(19) United States
(12) Patent Application Publication
(10) Pub. No.: US 2018/0290488 A1
(43) Pub. Date: Oct. 11, 2018

(54) DUAL-DIRECTION ACTUATING AXLE ASSEMBLY WITH ENHANCED DURABILITY

(71) Applicants: James Kaplan, Kansas City, KS (US); William Shao, Kansas City, KS (US); Jonathan Burr, Kansas City, KS (US)

(72) Inventors: James Kaplan, Kansas City, KS (US); William Shao, Kansas City, KS (US); Jonathan Burr, Kansas City, KS (US)

(21) Appl. No.: 15/947,394

(22) Filed: Apr. 6, 2018

Related U.S. Application Data
(60) Provisional application No. 62/482,623, filed on Apr. 6, 2017.

(51) Int. Cl. B60B 35/10; B60B 35/00

(52) U.S. Cl. CPC B60B 35/1054; B60B 35/003; B60Y 2200/15; B60B 2900/325; B60B 2900/321

(57) ABSTRACT

A dual-direction actuating axle assembly is coupled to a vehicle's pair of wheels and orbital head of a steering column. The axle assembly includes a beam, a first steering knuckle coupled to the beam's first end and a second steering knuckle coupled to the beam's second end, the first and second steering knuckles coupled to the wheels, an actuating assembly coupled to the beam and having an outer cylinder, a rod slidably mounted to the outer cylinder and a piston coupled to the rod, the rod coupled to the first and second steering knuckles. The vehicle's steering column is maneuvered to actuate the piston and rod in a first direction to pivotably adjust the pair of steering knuckles in a first direction. The vehicle's steering column is maneuvered to actuate the piston and rod in a second direction to pivotably adjust the pair of steering knuckles in a second direction.

### RELATED APPLICATION

The application claims priority to provisional patent application U.S. Ser. No. 62/482,623 filed on Apr. 6, 2017, the entire contents of which is herein incorporated by reference.

### BACKGROUND

The embodiments herein relate generally to axle assemblies used for connecting wheels in a vehicle. More specifically, embodiments of the invention relate to a dual-direction actuating axle assembly with enhanced durability and strength.

Ground vehicles generally comprise a plurality of wheels coupled to corresponding axles and suspension assemblies. Commonly used axle assemblies connecting the wheels to the steering system in vehicles such as baggage handler vehicles and tow vehicles for use with small aircraft or equipment such as forklifts have one or more limitations.

In particular, these axle assembles lack durability and are prone to premature wear and/or failure. This results from the design of the axle assembly, which often connects the axle to a steering knuckle and wheel by use of a pair of bushings and a single thrust bearing. The single thrust bearing supports the complete load of the vehicle, which accelerates the rate of wear and/or failure of the component and ultimately the axle assembly. In addition, several of these axle assemblies comprise components that require significant space, thereby making them difficult to accommodate vehicles with different engine configurations.

As such, there is a need in the industry for a dual-direction actuating axle assembly with enhanced strength and durability for use with a vehicle's steering mechanism that addresses the limitations of the prior art. There is a further need for the dual-direction actuating axle assembly that is more compact and space efficient to accommodate a wider variety of vehicles with different engine configurations.

### SUMMARY

A dual-direction actuating axle assembly with enhanced durability coupled to a pair of wheels of a vehicle is provided. The actuating axle assembly is mounted to a pair of leaf springs of the vehicle and operably connected to an orbital head of a steering column of the vehicle. The dual-direction actuating axle assembly comprises a beam comprising a first end and a second end, a pair of steering knuckles coupled to the beam and comprising a first steering knuckle and a second steering knuckle, the first steering knuckle coupled to the first end of the beam and the second steering knuckle coupled to the second end of the beam, the first and second steering knuckles coupled to the pair of wheels of the vehicle, an actuating assembly coupled to the beam and comprising an outer cylinder, a rod slidably mounted to the outer cylinder and a piston coupled to the rod, the rod comprising a first end coupled to the first steering knuckle and a second end coupled to the second steering knuckle, wherein the steering column of the vehicle is maneuvered to actuate the piston and rod of the actuating assembly in a first direction to pivotably adjust the pair of steering knuckles in a first direction, wherein the steering column of the vehicle is maneuvered to actuate the piston and rod of the actuating assembly in a second direction to pivotably adjust the pair of steering knuckles in a second direction.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the dual-direction actuating axle assembly shown in use;

FIG. 2 depicts a perspective view of certain embodiments of the dual-direction actuating axle assembly;

FIG. 3 depicts a top view of certain embodiments of the dual-direction actuating axle assembly;

FIG. 4 depicts a top view of certain embodiments of the dual-direction actuating axle assembly with the actuating assembly actuated for turning the vehicle's wheels left;

FIG. 5 depicts a top view of certain embodiments of the dual-direction actuating axle assembly with the actuating assembly actuated for turning the vehicle's wheels right;

FIG. 6 depicts a rear elevation view of certain embodiments of the dual-direction actuating axle assembly; and

FIG. 7 depicts a section view of certain embodiments of the dual-direction actuating axle assembly.

### DETAILED DESCRIPTION OF CERTAIN EMBODIMENTS

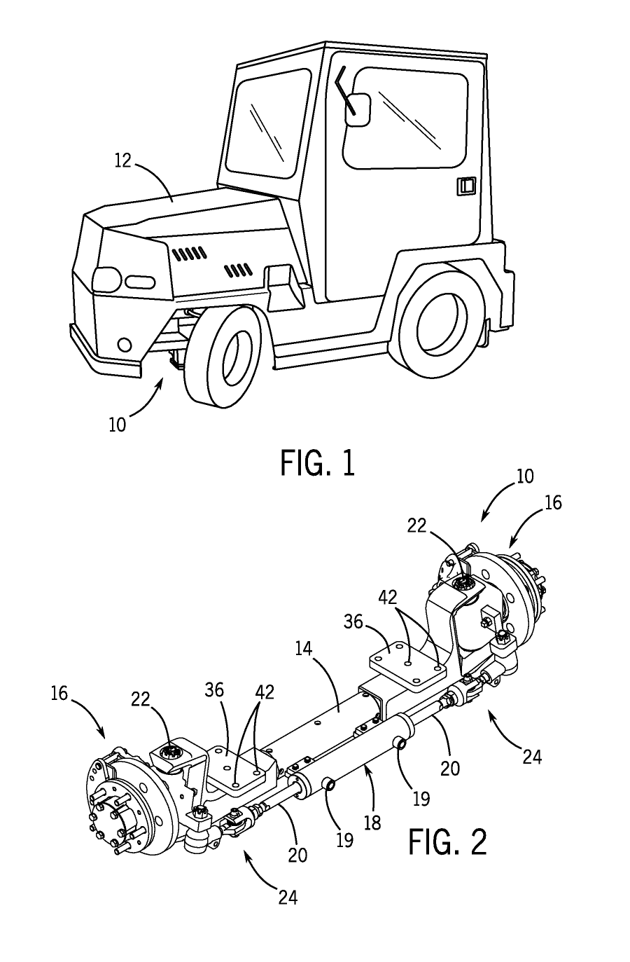

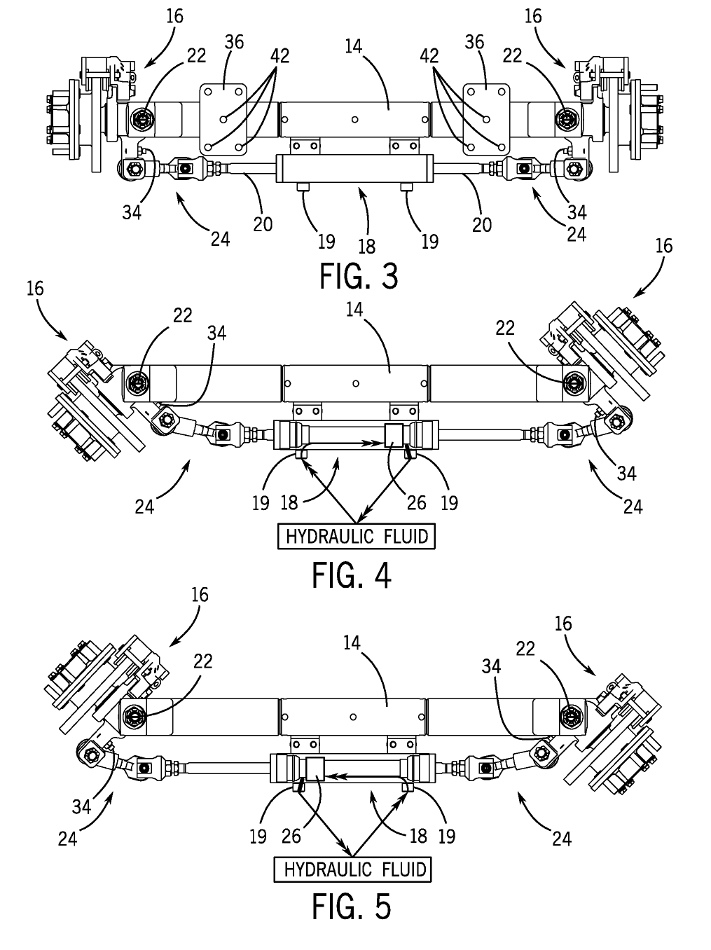

As depicted in FIGS. 1-3, dual-direction actuating axle assembly 10 is mounted to a frame of vehicle 12, coupled to a pair of steering wheels, and operably connected to an orbital head of the vehicle's steering column (not shown). Vehicle 12 preferably is any type of vehicle including, but not limited to, baggage handler vehicles commonly used at airports and tow vehicles designed for use with small aircraft and equipment such as forklifts, and the like. In one embodiment of the invention, the orbital head of vehicle 12 controls the flow of hydraulic fluid into dual-direction actuating axle assembly 10 to enable pivotal movement of the pair of connected steering wheels. This allows vehicle 12 to turn left or right when in motion.

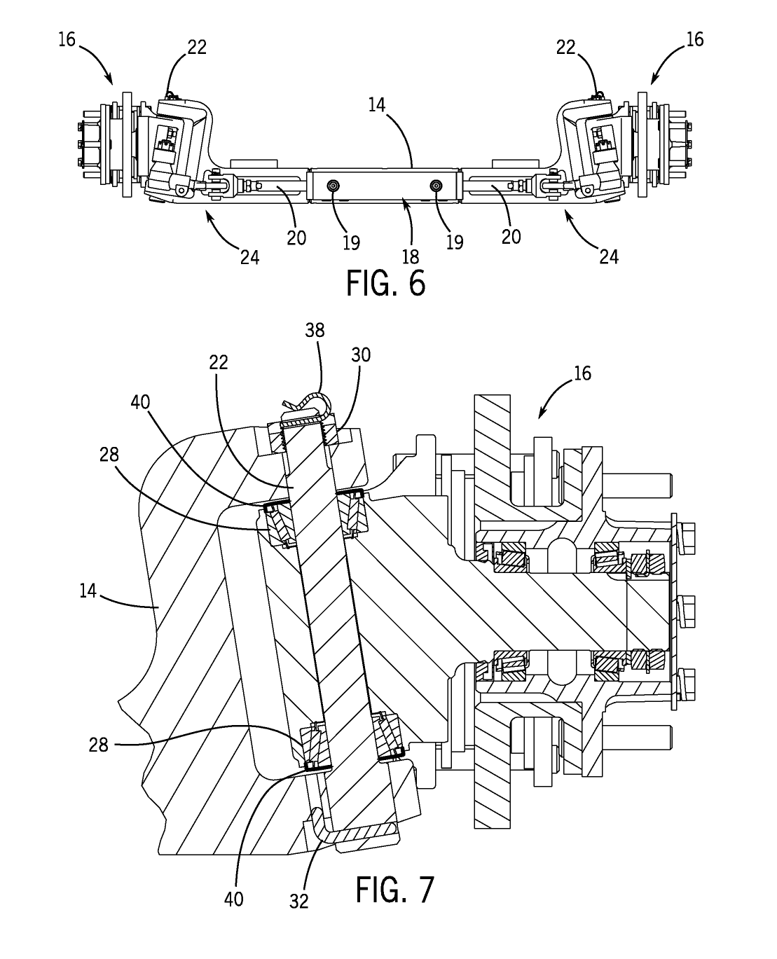

As depicted in FIGS. 2-6, dual-direction actuating axle assembly 10 generally comprises beam 14, steering knuckles 16, inner and outer tie-rod sets 24, and an actuating assembly comprising cylinder 18, rod 20 and piston 26.

Beam 14 is preferably made from a central tubular member connected to a pair of outer members mechanically fastened to a pair of steering knuckles 16 by kingpins 22. In a preferred embodiment, the central tubular member of beam 14 is made from A36 steel and the pair of outer members are made from forged steel. However, alternative materials known in the field may be used instead.

In one embodiment, a pair of mounting sheets 36 is coupled to the top of beam 14. Each mounting sheet 36 comprises a plurality of openings 42 configured to receive mechanical fasteners such as bolts (not shown). The bolts secure mounting sheets 36 to a pair of leaf springs in vehicle 12. The leaf springs may be any type commonly used in vehicles in the field. As such, mounting sheets 36 serve as mounting surfaces that secure the pair of leaf springs of vehicle 12 to dual-direction actuating axle assembly 10. In one embodiment, mounting sheets 36 are made from A36 steel. However, alternative materials known in the field may be used instead. In alternative embodiments, dual-direction actuating axle assembly 10 can be fix-mounted or coil spring mounted to vehicle 12.

In certain embodiments, the actuating assembly of dual-direction actuating axle assembly 10 can be configured for hydraulic or pneumatic operations. In a preferred embodiment, the actuating assembly is used in a hydraulic operation. In this embodiment, cylinder 18, rod 20 and piston 26 of the actuating assembly are coupled to beam 14. Specifically, cylinder 18 is coupled to the central tubular member of beam 14 using mechanical fasteners such as screws, bolts, nuts, and the like. In an alternative embodiment, cylinder 18 may be welded to beam 14. The central tubular member of beam 14 comprises a pair of ports 19 that are operably connected to the orbital head of the steering column of vehicle 12. Rod 20 is slidably mounted to the interior of cylinder 18 and comprises piston 26 coupled thereto. Slidable adjustments of rod 20 permit piston 26 to slidably adjust along the interior of cylinder 18. The components of the actuating assembly are preferably made from A36 steel. However, alternative materials known in the field may be used instead.

A pair of inner and outer tie-rod sets 24 couple the opposing ends of rod 20 to the pair of steering knuckles 16. The components of inner and outer tie-rod sets 24 and steering knuckles 16 are preferably made from A36 steel. However, alternative materials known in the field may be used instead. Each steering knuckle 16 is coupled to one of the pair of steering wheels of vehicle 12 as is known in the field using components such as a hub and rotor assembly and bearings. Each inner and outer tie-rod set 24 comprises a series of linkage arms that pivotably adjust relative to each other, which are configured to transfer movement of rod 20 to one of steering knuckles 16. This transfer of movement of rod 20 permits steering knuckles 16 to pivotably adjust.

Mechanical fasteners such as bolts, castle nuts, and the like may be used to couple the ends of rod 20 to the pair of inner and outer tie-rod sets 24. In one embodiment, an axle stop protrusion 34 is coupled to each inner and outer tie-rod set 24. In one embodiment, each axle stop protrusion 34 comprises a nut disposed around a protruding shaft.

Each steering knuckle 16 is coupled to an end of beam 14 by kingpin 22. As depicted in FIG. 7, kingpin 22 is disposed through each adjacent pair of steering knuckle 16 and an end of an outer member of beam 14. Mechanical fasteners are used to secure kingpin 22 to beam 14 and steering knuckle 16. Specifically, anti-rotation pin 32 is coupled to a first end of kingpin 22. Castle nut 30 is coupled to the second end of kingpin 22 and retained in place by hair pin 38. A pair of tapered thrust bearings 28 are disposed around kingpin 22 and in contact with steering knuckle 16. In a preferred embodiment, the first thrust bearing 28 is positioned on an upper portion of kingpin 22 and the second thrust bearing 28 is positioned on a lower portion of kingpin 22.

The pair of thrust bearings 28 in this configuration are advantageous because they reduce friction during pivotal movement of steering knuckle 16 relative to beam 14. In addition, thrust bearings 28 together support the load of vehicle 12 and help to minimize wear of the components at the pivoting joints in dual-direction actuating axle assembly 10.

In one embodiment, a grease fitting is coupled to dual-direction actuating axle assembly 10 to provide grease to the pair of thrust bearings 28. This ensures thrust bearings 28 are sufficiently lubricated to ensure the smooth pivotal movement of steering knuckles 16 relative to beam 14. Grease seals 40 are coupled to the pair of thrust bearings 28 to prevent grease from leaking out the grease fitting. Grease seals 40 also prevent water, other fluids and debris from entering the grease fitting. In a preferred embodiment, grease seals 40 are made from a steel and vulcanized rubber combination. However, alternative materials known in the field may be used instead.

In operation, a user operates vehicle 12 in a conventional manner. The user rotates the steering wheel of vehicle 12 to rotate the steering column shaft of vehicle 12. Since the steering column shaft is operably connected to the orbital head of vehicle 12, the rotation of the steering column shaft permits the orbital head to control the flow of hydraulic fluid via one or more valves to ports 19 of cylinder 18 of the hydraulic assembly as depicted in FIGS. 4-5.

FIG. 4 depicts an operation when the hydraulic assembly of dual-direction actuating axle assembly 10 is actuated to turn the pair of steering wheels of vehicle 12 left. In this operation, the rotation of the steering wheel of vehicle 12 counterclockwise permits hydraulic fluid from the orbital head to travel through first port 19 into cylinder 18 and out of second port 19 as illustrated by the arrows in FIG. 4. The pressure created by the movement of hydraulic fluid on piston 26 within cylinder 18 causes rod 20 to slidably adjust relative to cylinder 18, which pivotably adjusts the pair of steering knuckles 16 in a first direction to permit vehicle 12 to travel in a left turn path.

Similarly, FIG. 5 depicts an operation when the hydraulic assembly of dual-direction actuating axle assembly 10 is actuated to turn the pair of steering wheels of vehicle 12 right. In this operation, the rotation of the steering wheel of vehicle 12 clockwise permits hydraulic fluid from the orbital head to travel through second port 19 into cylinder 18 and out of first port 19 as illustrated by the arrows in FIG. 5. The pressure created by the movement of hydraulic fluid on piston 26 within cylinder 18 causes rod 20 to slidably adjust relative to cylinder 18, which pivotably adjusts the pair of steering knuckles 16 in a second direction to permit vehicle 12 to travel in a right turn path. During the operation of the hydraulic assembly, it shall be appreciated that the same amount of hydraulic fluid is displaced through cylinder 18 for both left and right turns of vehicle 12.

The pair of axle stop protrusions 34 are configured to contact beam 14 and limit the pivotal movement of the pair of steering knuckles 16. As such, axle stop protrusions 34 serve as obstructions that prevent excessive pivotal movement of steering knuckles 16 that will result in the breakage of the pair of inner and outer tie-rod sets 24.

It shall be appreciated that the components of the dual-direction actuating axle assembly 10 described in several embodiments herein may comprise any alternative known materials in the field and be of any color, size and/or dimensions. It shall be appreciated that the components of dual-direction actuating axle assembly 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention, the scope of the invention is reflected by the breadth of the claims below rather than narrowed by the embodiments described above.

What is claimed is:

1. A dual-direction actuating axle assembly with enhanced durability coupled to a pair of wheels of a vehicle, the actuating axle assembly mounted to a pair of leaf springs of the vehicle and operably connected to an orbital head of a steering column of the vehicle, the dual-direction actuating axle assembly comprising:
a beam comprising a first end and a second end;
a pair of steering knuckles coupled to the beam and comprising a first steering knuckle and a second steering knuckle, the first steering knuckle coupled to the first end of the beam and the second steering knuckle coupled to the second end of the beam, the first and second steering knuckles coupled to the pair of wheels of the vehicle;
an actuating assembly coupled to the beam and comprising an outer cylinder, a rod slidably mounted to the outer cylinder and a piston coupled to the rod, the rod comprising a first end coupled to the first steering knuckle and a second end coupled to the second steering knuckle;
wherein the steering column of the vehicle is maneuvered to actuate the piston and rod of the actuating assembly in a first direction to pivotably adjust the pair of steering knuckles in a first direction, wherein the steering column of the vehicle is maneuvered to actuate the piston and rod of the actuating assembly in a second direction to pivotably adjust the pair of steering knuckles in a second direction.

2. The dual-direction actuating axle assembly of claim 1, wherein the outer cylinder of the actuating assembly comprises a pair of ports operably connected to the orbital head of the vehicle.

3. The dual-direction actuating axle assembly of claim 2, wherein the actuating assembly is actuated in an hydraulic operation, wherein fluid from the orbital head of the vehicle travels through the first port in the pair of ports into the outer cylinder and out the second port in the pair of ports to adjust the pair of steering knuckles in the first direction, wherein fluid from the orbital head of the vehicle travels through the second port in the pair of ports into the outer cylinder and out the first port in the pair of ports to adjust the pair of steering knuckles in the second direction.

4. The dual-direction actuating axle assembly of claim 2, further comprising a first inner and outer tie-rod set coupled to the first end of the rod and first steering knuckle and a second inner and outer tie-rod set coupled to the second end of the rod and second steering knuckle.

5. The dual-direction actuating axle assembly of claim 4, further comprising a first kingpin coupled to both the first steering knuckle and beam and a second kingpin coupled to both the second steering knuckle and beam, each kingpin in the first and second kingpins comprising an upper thrust bearing and a lower thrust bearing both disposed on the kingpin and in contact with one of the first and second steering knuckles.

6. The dual-direction actuating axle assembly of claim 5, wherein each kingpin in the first and second kingpins comprises a pin coupled to the first end of the kingpin and a nut coupled to the second end of the kingpin.

7. The dual-direction actuating axle assembly of claim 6, wherein each kingpin in the first and second kingpins comprises a clip coupled to the second end of the kingpin and the nut.

8. The dual-direction actuating axle assembly of claim 7, wherein each kingpin in the first and second kingpins comprises a first grease seal coupled to the upper thrust bearing and a second grease seal coupled to the lower thrust bearing.

9. The dual-direction actuating axle assembly of claim 8, further comprising a first axle stop protrusion coupled to the first inner and outer tie-rod set and a second axle stop protrusion coupled to the second inner and outer tie-rod set, the first and second axle stop protrusions configured to contact the beam and limit pivotal movement of the pair of steering knuckles.

10. The dual-direction actuating axle assembly of claim 9, further comprising a pair of mounting sheets coupled to the beam and the pair of leaf springs of the vehicle.
